(19) United States
(12) Patent Application Publication
(10) Pub. No.: US 2025/0311052 A1
(43) Pub. Date: Oct. 2, 2025

(54) SYSTEMS AND METHODS FOR MANAGING REMOTELY INITIATED MISSION CRITICAL PUSH TO TALK (MCPTT) CALLS

(71) Applicant: Samsung Electronics Co., Ltd., Suwon-si, Gyeonggi-do (KR)

(72) Inventors: Kiran Gurudev KAPALE, Bangalore (IN); Arunprasath RAMAMOORTHY, Bangalore (IN)

(21) Appl. No.: 18/864,354

(22) PCT Filed: May 4, 2023
(86) PCT No.: PCT/KR2023/006132

§ 371 Date: Nov. 8, 2024

(30) Foreign Application Priority Data
May 9, 2022 (IN) 202241026779
Apr. 6, 2023 (IN) 2022 41026779

(51) Int. Cl. H04W 76/45; H04W 4/10; H04W 12/06; H04W 76/10

(52) U.S. Cl. CPC H04W 76/45; H04W 4/10; H04W 12/06; H04W 76/10

(57) ABSTRACT

The disclosure relates to a 5G or 6G communication system for supporting a higher data transmission rate. Embodiments herein disclose systems and methods for managing remotely initiated MCPTT calls, The method includes checking, by an MCPTT server, whether a first MCPTT client is authorized to initiate an MCPTT call request with a second MCPTT client, on receiving a remotely initiated MCPTT call request from a second MCPTT client. If the first MCPTT client is authorized to remotely initiate MCPTT call request with the second MCPTT client, and if the second MCPTT client is a member of the MCPTT group, then the method includes affiliating, by the MCPTT server, the second MCPTT client to the MCPTT group for joining the remotely initiated MCPTT call request. The method includes initiating, by second MCPTT client, MCPTT call establishment procedure with first MCPTT client.

### CROSS-REFERENCE TO RELATED APPLICATION(S)

This application is a U.S. National Stage application under 35 U.S.C. § 371 of an International application number PCT/KR2023/006132, filed on May 4, 2023, which is based on and claims priority of an Indian Provisional application number 202241026779, filed on May 9, 2022, in the Indian Patent Office, and of an Indian Complete patent application number 202241026779 filed on Apr. 6, 2023, in the Indian Patent Office, the disclosure of each of which is incorporated by reference herein in its entirety.

### TECHNICAL FIELD

Embodiments disclosed herein relate to wireless communication networks and more particularly to systems and methods for managing remotely initiated Mission Critical Push to Talk (MCPTT) calls.

### BACKGROUND ART

5G mobile communication technologies define broad frequency bands such that high transmission rates and new services are possible, and can be implemented not only in “Sub 6 GHz” bands such as 3.5 GHz, but also in “Above 6 GHz” bands referred to as mmWave including 28 GHz and 39 GHz. In addition, it has been considered to implement 6G mobile communication technologies (referred to as Beyond 5G systems) in terahertz bands (for example, 95 GHz to 3 THz bands) in order to accomplish transmission rates fifty times faster than 5G mobile communication technologies and ultra-low latencies one-tenth of 5G mobile communication technologies.

At the beginning of the development of 5G mobile communication technologies, in order to support services and to satisfy performance requirements in connection with enhanced Mobile BroadBand (eMBB), Ultra Reliable Low Latency Communications (URLLC), and massive Machine-Type Communications (mMTC), there has been ongoing standardization regarding beamforming and massive MIMO for mitigating radio-wave path loss and increasing radio-wave transmission distances in mmWave, supporting numerologies (for example, operating multiple subcarrier spacings) for efficiently utilizing mmWave resources and dynamic operation of slot formats, initial access technologies for supporting multi-beam transmission and broadbands, definition and operation of BWP (BandWidth Part), new channel coding methods such as a LDPC (Low Density Parity Check) code for large amount of data transmission and a polar code for highly reliable transmission of control information, L2 pre-processing, and network slicing for providing a dedicated network specialized to a specific service.

Currently, there are ongoing discussions regarding improvement and performance enhancement of initial 5G mobile communication technologies in view of services to be supported by 5G mobile communication technologies, and there has been physical layer standardization regarding technologies such as V2X (Vehicle-to-everything) for aiding driving determination by autonomous vehicles based on information regarding positions and states of vehicles transmitted by the vehicles and for enhancing user convenience, NR-U (New Radio Unlicensed) aimed at system operations conforming to various regulation-related requirements in unlicensed bands, NR UE Power Saving, Non-Terrestrial Network (NTN) which is UE-satellite direct communication for providing coverage in an area in which communication with terrestrial networks is unavailable, and positioning.

Moreover, there has been ongoing standardization in air interface architecture/protocol regarding technologies such as Industrial Internet of Things (IIoT) for supporting new services through interworking and convergence with other industries, IAB (Integrated Access and Backhaul) for providing a node for network service area expansion by supporting a wireless backhaul link and an access link in an integrated manner, mobility enhancement including conditional handover and DAPS (Dual Active Protocol Stack) handover, and two-step random access for simplifying random access procedures (2-step RACH for NR). There also has been ongoing standardization in system architecture/service regarding a 5G baseline architecture (for example, service based architecture or service based interface) for combining Network Functions Virtualization (NFV) and Software-Defined Networking (SDN) technologies, and Mobile Edge Computing (MEC) for receiving services based on UE positions.

As 5G mobile communication systems are commercialized, connected devices that have been exponentially increasing will be connected to communication networks, and it is accordingly expected that enhanced functions and performances of 5G mobile communication systems and integrated operations of connected devices will be necessary. To this end, new research is scheduled in connection with eXtended Reality (XR) for efficiently supporting AR (Augmented Reality), VR (Virtual Reality), MR (Mixed Reality) and the like, 5G performance improvement and complexity reduction by utilizing Artificial Intelligence (AI) and Machine Learning (ML), AI service support, metaverse service support, and drone communication.

Furthermore, such development of 5G mobile communication systems will serve as a basis for developing not only new waveforms for providing coverage in terahertz bands of 6G mobile communication technologies, multi-antenna transmission technologies such as Full Dimensional MIMO (FD-MIMO), array antennas and large-scale antennas, metamaterial-based lenses and antennas for improving coverage of terahertz band signals, high-dimensional space multiplexing technology using OAM (Orbital Angular Momentum), and RIS (Reconfigurable Intelligent Surface), but also full-duplex technology for increasing frequency efficiency of 6G mobile communication technologies and improving system networks, AI-based communication technology for implementing system optimization by utilizing satellites and AI (Artificial Intelligence) from the design stage and internalizing end-to-end AI support functions, and next-generation distributed computing technology for implementing services at levels of complexity exceeding the limit of UE operation capability by utilizing ultra-high-performance communication and computing resources

Mission critical services, that are used by public safety communities (such as police, military, fire services, ambulance crews, and the like) in their operations, require high reliability, speed, quick accessibility and low latency operational support.

A quick set up of a call is very critical for the public safety communities and the mission critical (MC) operations. Any operation requires a number of pre-conditions to be met upfront. Establishing of target MCPTT group communication on receiving of a remotely initiated call request also requires a number of pre-conditions to be met. One such important pre-condition is an affiliation to and de-affiliation from the target MCPTT group by the receiving MCPTT client (remote user) of the MCPTT user of the remotely initiated call request. There are numerous ways to achieve such pre-conditions. The existing procedure expects the affiliation to be performed using explicit procedure by an authorized user before the remotely initiated call request is being triggered.

The remotely initiated MCPTT communication procedure is described in the specification 3rd generation partnership project (3GPP) technical specification (TS 23.379) and FIG. 1 depicts the existing remotely initiated MCPTT call request procedure 100. The existing remotely initiated MCPTT call request procedure 100 includes a set of pre-conditions, wherein the set of pre-conditions has to be satisfied prior to invoking of the procedure. The pre-conditions are as follows: if a first MCPTT user on a first MCPTT client 102 wants a resulting remotely initiated MCPTT call to be an MCPTT group call, then a second MCPTT user on a second MCPTT client 106 is an affiliated MCPTT group member of the MCPTT group that is a target of the remotely initiated MCPTT call. Otherwise, prior to the procedures, the first MCPTT user on the first MCPTT client 102 can use existing procedures (for e.g., remotely change MCPTT group affiliation (10.3.5.1.1), if authorized, to satisfy the necessary preconditions for the second MCPTT user on the second MCPTT client 106 to initiate an MCPTT group call from that MCPTT group. If the call request is an MCPTT private call, then the second MCPTT user on the second MCPTT client 104 is permitted to initiate an MCPTT private call to the identified MCPTT user.

If the authorized user wants the resulting remotely initiated MCPTT call to be an MCPTT group call, then the remotely initiated MCPTT call request receiving user (remote user) should be affiliated to that group and if not affiliated, then the authorized user can use existing procedures (e.g., remotely change MCPTT group affiliation) to satisfy the necessary preconditions for the remote user to initiate an MCPTT group call on that MCPTT group. A two-step procedure is required in this existing procedure (i.e., affiliate a user, and send a remotely initiated MCPTT call request) which can add delays in the communication setup and multiple operations are required. Hence there is a need for optimizing the communication setup and to overcome the use of multiple operations.

Referring to FIG. 1, the first MCPTT client 102 (or the first MCPTT user on the first MCPTT client 102) initiates the remotely initiated MCPTT call request to the MCPTT client 2 106 (or the MCPTT user of MCPTT client 2 106) in operation 112. The first MCPTT client 102 (or the first MCPTT user on the first MCPTT client 102) transmits the remotely initiated MCPTT call request to the MCPTT server 104 in operation 114. After receiving the remotely initiated MCPTT call request from the first MCPTT client 102 (or the first MCPTT user on the first MCPTT client 102), the MCPTT server 104 authorizes the request in operation 116.

After authorizing the request, the MCPTT server 104 transmits the remotely initiated MCPTT call request to the second MCPTT client 106 (or the second MCPTT user on the second MCPTT client 106) in operation 118. After receiving the remotely initiated MCPTT call request from the MCPTT server 104, the second MCPTT client 106 (or the second MCPTT user on the second MCPTT client 106) notifies the user of the remotely initiated MCPTT call request in operation 120.

After notifying the user of the remotely initiated MCPTT call request, the second MCPTT client 106 (or the second MCPTT user on the second MCPTT client 106) optionally transmits a remotely initiated MCPTT call response to the MCPTT server 104 in operation 122. After receiving the remotely initiated MCPTT call response from the second MCPTT client 106 (or the second MCPTT user on the second MCPTT client 106), the MCPTT server 104 optionally transmits the remotely initiated MCPTT call response to the first MCPTT client 102 (or the first MCPTT user on the first MCPTT client 102) in operation 124.

Thereafter, an MCPTT call is initiated between the first MCPTT client 102 (or the first MCPTT user on the first MCPTT client 102) and the second MCPTT client 106 (or the second MCPTT user on the second MCPTT client 106) in operation 126.

### DISCLOSURE

### Technical Solution

The principal object of the embodiments herein is to disclose systems and methods for managing remotely initiated an MCPTT call, where a receiving user of a remotely initiated call request is implicitly affiliated by the server on receiving the request to initiate the remotely initiated call from an authorized user.

Another object of the embodiments herein is to disclose implicitly affiliation of a user of the call originator by server on receiving the call setup request which is a result of the remotely initiated call request from the authorized user.

Another object of the embodiments herein is to disclose implicitly de-affiliation of a call originator by a server while terminating the call which was established as a result of the remotely initiated call request from the authorized user is received by the user of call originator.

Accordingly, the embodiments herein provide a method for managing remotely initiated Mission Critical Push to Talk (MCPTT) calls. The method includes receiving, by an MCPTT server, a remotely initiated MCPTT call request from a second MCPTT client (106). The method further includes checking, by the MCPTT server, whether an MCPTT user at a first MCPTT client is authorized to initiate a remotely initiated MCPTT call request for an MCPTT group. The method further includes determining If the first MCPTT client is authorized to remotely initiate the MCPTT call request with the second MCPTT client, and if the second MCPTT client is a member of the MCPTT group, then the method further includes affiliating, by the MCPTT server, the second MCPTT client to the MCPTT group for joining the remotely initiated MCPTT call request.

Embodiments herein disclose that the method further includes initiating, by the second MCPTT client, an MCPTT call establishment procedure with the first MCPTT client.

Embodiments herein disclose that the method further includes de-affiliating, by the MCPTT server, the second MCPTT client from the MCPTT group once the on-going remotely initiated MCPTT call has been terminated.

Embodiments herein disclose that the method further includes requesting, by the first MCPTT client, the remotely initiated MCPTT call to the MCPTT server.

Embodiments herein disclose that the method further includes sending, by the MCPTT server, the remotely initiated call MCPTT request to the second MCPTT client. The method further includes responding, by the second MCPTT client, to the remotely initiated MCPTT call request from the MCPTT server. The method further includes informing, by the MCPTT server, the response of the second MCPTT client to the first MCPTT client.

Embodiments herein disclose that the method further includes notifying, by the MCPTT server, affiliation changes to the second MCPTT client, if the second MCPTT client is not a member of the MCPTT group.

Embodiments herein disclose that the remotely initiated MCPTT call request includes at least one of a group call or a private call.

In an aspect, the embodiments herein provide a system for managing remotely initiated Mission Critical Push to Talk (MCPTT) calls. The system includes a first MCPTT client, an MCPTT server, and a second MCPTT client. The system is configured to check whether a first MCPTT client is authorized to initiate an MCPTT call request with a second MCPTT client, on receiving a remotely initiated MCPTT call request from the first MCPTT client. If the first MCPTT client is authorized to remotely initiate the MCPTT call request with the second MCPTT client, and if the second MCPTT client is a member of the MCPTT group, then the system is configured to affiliate the second MCPTT client to the MCPTT group for joining the remotely initiated MCPTT call request. The system is configured to initiate an MCPTT call establishment procedure with the first MCPTT client.

Embodiments herein disclose that the system is further configured to de-affiliate the second MCPTT client from the MCPTT group once the on-going remotely initiated MCPTT call has been terminated.

Embodiments herein disclose that the system is further configured to request the remotely initiated MCPTT call to the MCPTT server.

Embodiments herein disclose that the system is further configured to send the remotely initiated call MCPTT request to the second MCPTT client. The system is further configured to respond to the remotely initiated MCPTT call request from the MCPTT server. The system is further configured to inform the response of the second MCPTT client to the first MCPTT client.

Embodiments herein disclose that the system is further configured to notify affiliation changes to the second MCPTT client, if the second MCPTT client is not a member of the MCPTT group.

Embodiments herein disclose that the remotely initiated MCPTT call request includes at least one of a group call or a private call.

In another aspect, the embodiments herein provide a Mission Critical Push to Talk (MCPTT) server. The MCPTT server includes a memory, at least one processor, and an MCPTT group controller. The MCPTT group controller connected to the memory and the at least one processor configured receive a remotely initiated MCPTT call request from a second MCPTT client (106). whether an MCPTT user at a first MCPTT client is authorized to initiate a remotely initiated MCPTT call request for an MCPTT group. If the first MCPTT client is authorized to remotely initiate the MCPTT call request with the second MCPTT client, and if the second MCPTT client is a member of the MCPTT group, then the MCPTT group controller is further configured to affiliate the second MCPTT client to the MCPTT group for joining the remotely initiated MCPTT call request.

Embodiments herein disclose that the MCPTT group controller is further configured to de-affiliate the second MCPTT client from the MCPTT group once the on-going remotely initiated MCPTT call has been terminated.

Embodiments herein disclose that the remotely initiated MCPTT call request includes at least one of a group call or a private call.

These and other aspects of the embodiments herein will be better appreciated and understood when considered in conjunction with the following description and the accompanying drawings. It should be understood, however, that the following descriptions, while indicating at least one embodiment and numerous specific details thereof, are given by way of illustration and not of limitation. Many changes and modifications may be made within the scope of the embodiments herein without departing from the spirit thereof, and the embodiments herein include all such modifications.

### DESCRIPTION OF DRAWINGS

The embodiments disclosed herein are illustrated in the accompanying drawings, throughout which like reference letters indicate corresponding parts in the various figures. The embodiments herein will be better understood from the following description with reference to the drawings, in which:

FIG. 1 depicts a flow diagram of an existing procedure for a remotely initiated MCPTT call request procedure, according to prior arts;

FIG. 2 depicts a system for managing remotely initiated MCPTT calls, according to embodiments as disclosed herein;

FIG. 3 shows various hardware components of an MCPTT server for managing remotely initiated MCPTT calls, according to embodiments as disclosed herein;

FIG. 4 depicts a flow diagram for an affiliation and a de-affiliation of an MCPTT group by the MCPTT server on reception the remotely initiated MCPTT call request and termination of the call, according to embodiments as disclosed herein;

FIG. 5 depicts a flow diagram for an affiliation and a de-affiliation of an MCPTT group by the MCPTT server on reception of an MCPTT call setup request and termination, according to embodiments as disclosed herein;

FIG. 6 depicts a method managing remotely initiated MCPTT calls, according to embodiments as disclosed herein; and

FIG. 7 depicts a method of affiliating a second MCPTT user by the MCPTT server after initiating an MCPTT group call request, according to embodiments as disclosed herein.

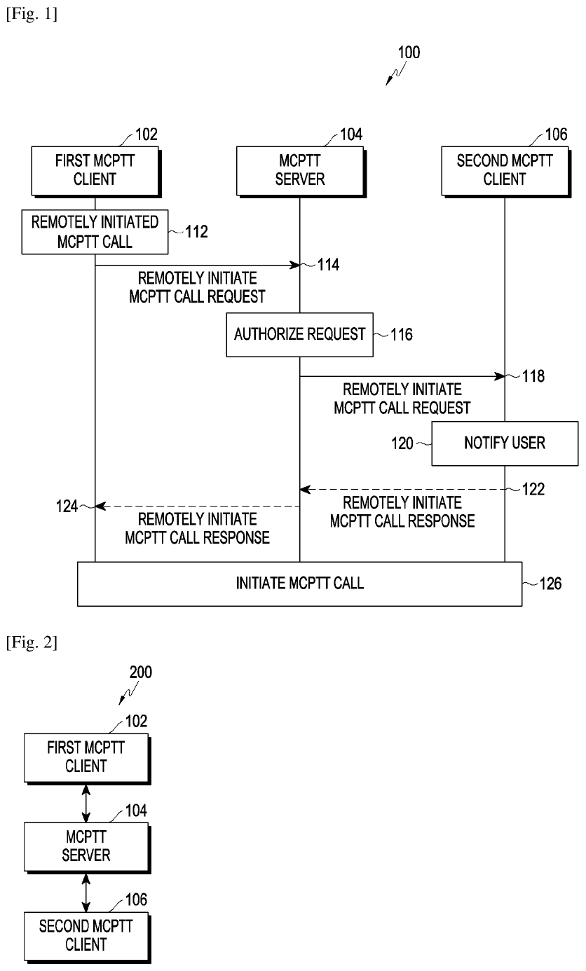

### MODE FOR INVENTION

The embodiments herein and the various features and advantageous details thereof are explained more fully with reference to the non-limiting embodiments that are illustrated in the accompanying drawings and detailed in the following description. Descriptions of well-known components and processing techniques are omitted so as to not unnecessarily obscure the embodiments herein. The examples used herein are intended merely to facilitate an understanding of ways in which the embodiments herein can be practiced and to further enable those of skill in the art to practice the embodiments herein. Accordingly, the examples should not be construed as limiting the scope of the embodiments herein.

The embodiments herein achieve systems and methods for managing a Mission Critical Push to Talk (MCPTT) call. Referring now to the drawings, and more particularly to FIGS. 2 through 7, where similar reference characters denote corresponding features consistently throughout the figures, there are shown at least one embodiment.

FIG. 2 depicts a system 200 for managing remotely initiated MCPTT calls, according to embodiments as disclosed herein. The system 200 includes a first MCPTT client 102, an MCPTT server 104, and a second MCPTT client 106. The first MCPTT client 102 initiates a remotely initiated MCPTT call request with the second MCPTT client 106 through the MCPTT server 104. The remotely initiated MCPTT call request includes at least one of a group call or a private call. The MCPTT server 104 checks whether the first MCPTT client is authorized to initiate the MCPTT call request with the second MCPTT client, on receiving the remotely initiated MCPTT call request from the second MCPTT client. The first MCPTT client 102 determines if the first MCPTT client is authorized to remotely initiate the MCPTT call request with the second MCPTT client, and if the second MCPTT client is a member of the MCPTT group, then the MCPTT server 104 affiliates the second MCPTT client to the MCPTT group for joining the remotely initiated MCPTT call request. After the second MCPTT client 106 is affiliated, the second MCPTT client 106 initiates an MCPTT call establishment procedure with the first MCPTT client 102.

FIG. 3 shows various hardware components of an MCPTT server 104 for managing remotely initiated MCPTT calls, according to embodiments as disclosed herein. The MCPTT server includes a memory 330, at least one processor 340, and an MCPTT group controller 310. The MCPTT group controller 310 is connected to the memory 330. The at least one processor 340 is configured to check the first MCPTT client's configurations to determine whether a first MCPTT client 102 is authorized to initiate an MCPTT call request with a second MCPTT client 106, on receiving a remotely initiated MCPTT call request from the first MCPTT client 102. If the first MCPTT client is authorized to remotely initiate the MCPTT call request with the second MCPTT client 106, and if the second MCPTT client 106 is a member of the MCPTT group, then the MCPTT group controller 310 is further configured to affiliate the second MCPTT client to the MCPTT group for joining the remotely initiated MCPTT call request.

Embodiments herein disclose that the MCPTT group controller 310 is further configured to de-affiliate the second MCPTT client from the MCPTT group once the on-going remotely initiated MCPTT call request has been terminated.

For example, consider a first MCPTT user on the first MCPTT client 102 initiates a remotely initiated MCPTT call request to a second MCPTT user of the second MCPTT client 106. The first MCPTT client 102 sends the remotely initiated MCPTT call request towards the MCPTT server 104. The MCPTT server 104 checks whether the first MCPTT user at the first MCPTT client 102 is authorized to initiate a remotely initiated MCPTT call request. If authorized, the MCPTT server 104 sends the corresponding remotely initiated MCPTT call request towards the second MCPTT client 106. Based on the received information, the second MCPTT client 106 may notify the user of the remotely initiated MCPTT call request. Optionally, the receiving second MCPTT client 106 sends the remotely initiated MCPTT call response to the MCPTT server 104. After receiving the remotely initiated MCPTT call response from the second MCPTT client 106, the MCPTT server 104 informs the first MCPTT client 102 about the successful remotely initiated MCPTT call request. Based on the received information, the second MCPTT client 106 initiates an MCPTT call (either an MCPTT group call or an MCPTT private call) using a normal MCPTT call establishment procedures (10.6.2.3.1.1.2 or 10.7.2.2) with an implicit floor request. If required, the MCPTT server 104 implicitly affiliates the second MCPTT user on the second MCPTT client 106 to the MCPTT group, if the second MCPTT client 106 is not already affiliated and notifies the second MCPTT client 106 of the affiliation change. The indication provided in the call initiation request can be used to determine if the MCPTT group call is a result of a remotely initiated call request and affiliation can be performed based on the indication.

Further, the processor 340 is configured to execute instructions stored in the memory 330 and to perform various processes. The communicator 320 is configured for communicating internally between internal hardware components and with external devices via one or more networks. The memory 330 also stores instructions to be executed by the processor 340. The memory 330 may include non-volatile storage elements. Examples of such non-volatile storage elements may include magnetic hard discs, optical discs, floppy discs, flash memories, or forms of electrically programmable memories (EPROM) or electrically erasable and programmable (EEPROM) memories. In addition, the memory 130 may, in some examples, be considered a non-transitory storage medium. The term “non-transitory” may indicate that the storage medium is not embodied in a carrier wave or a propagated signal. However, the term “non-transitory” should not be interpreted that the memory 330 is non-movable. In certain examples, a non-transitory storage medium may store data that can, over time, change (e.g., in Random Access Memory (RAM) or cache).

At least one of the plurality of modules may be implemented through an artificial intelligence (AI) model. A function associated with the AI model may be performed through the non-volatile memory, the volatile memory 330, and the processor 340. The processor 340 may include one or a plurality of processors. At this time, one or a plurality of processors may be a general-purpose processor, such as a central processing unit (CPU), an application processor (AP), or the like, a graphics-only processing unit such as a graphics processing unit (GPU), a visual processing unit (VPU), and/or an AI-dedicated processor such as a neural processing unit (NPU).

The one or a plurality of processors control the processing of the input data in accordance with a predefined operating rule or the AI model stored in the non-volatile memory and the volatile memory. The predefined operating rule or artificial intelligence model can be provided through training or learning.

Here, being provided through learning means that a predefined operating rule or AI model of a desired characteristic is made by applying a learning algorithm to a plurality of learning data. The learning may be performed in a device itself in which AI according to an embodiment is performed, and/o may be implemented through a separate server/system.

The AI model may include of a plurality of neural network layers. Each layer has a plurality of weight values, and performs a layer operation through calculation of a previous layer and an operation of a plurality of weights. Examples of neural networks include, but are not limited to, convolutional neural network (CNN), deep neural network (DNN), recurrent neural network (RNN), restricted Boltzmann Machine (RBM), deep belief network (DBN), bidirectional recurrent deep neural network (BRDNN), generative adversarial networks (GAN), and deep Q-networks.

The learning algorithm is a method for training a predetermined target device (for example, a robot) using a plurality of learning data to cause, allow, or control the target device to make a determination or prediction. Examples of learning algorithms include, but are not limited to, supervised learning, unsupervised learning, semi-supervised learning, or reinforcement learning.

Although the FIG. 3 shows various hardware components of the MCPTT server 104 but it is to be understood that other embodiments are not limited thereon. In other embodiments, the MCPTT server 104 may include less or a greater number of components. Further, the labels or names of the components are used only for illustrative purpose and does not limit the scope of the invention. One or more components can be combined together to perform same or substantially similar function in MCPTT server 104.

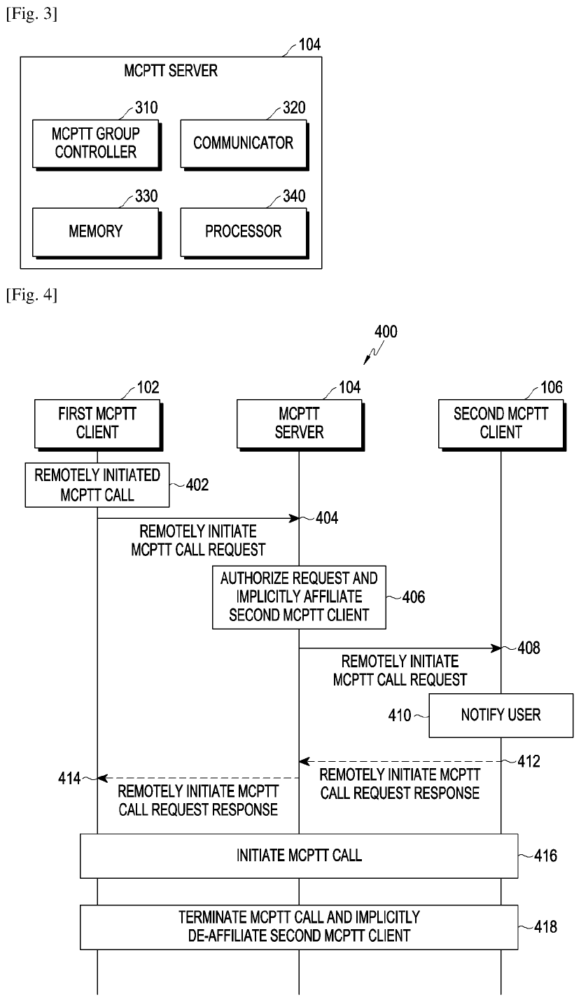

FIG. 4 depicts a flow diagram 400 for the affiliation and the de-affiliation of an MCPTT group by the MCPTT server 104 on reception the remotely initiated MCPTT call request and resulted call termination, according to embodiments as disclosed herein. At steps 402 and 404, the first MCPTT client 102 initiates the remotely initiated MCPTT call request to the MCPTT server 104. At step 406, the MCPTT server 104 authorizes the remotely initiated MCPTT call request by implicitly affiliating the second MCPTT client 106. At step 408, the MCPTT server 104 sends the remotely initiated MCPTT call request to the second MCPTT client 106. At step 410, the remotely initiated MCPTT call request is notified to a second MCPTT client user by the second MCPTT client 106. At step 412, the second MCPTT client 106 sends a remotely initiated MCPTT call request response to the MCPTT server 104. At step 414, the MCPTT server 104 sends the remotely initiated MCPTT call request response from the second MCPTT client 106 to the first MCPTT client 102. At step 416, the second MCPTT client 106 initiates the call establishment procedure with the first MCPTT client 102. At step 418, the MCPTT server 104 de-affiliates the second MCPTT client 106, once the on-going session has been terminated. Further, in some embodiments, some actions listed in FIG. 4 may be omitted.

FIG. 4 will be described once again as follows. FIG. 4 illustrates a procedure for affiliating a remote user to a target MCPTT group is performed by an MCPTT server on reception of a remotely initiated MCPTT call request and de-affiliating from the target MCPTT group on termination of on-going MCPTT group call.

In an embodiment, pre-conditions may be as follows:

If an MCPTT user at a first MCPTT client 102 wants a resulting remotely initiated MCPTT call to be:
a. an MCPTT group call, then an MCPTT user at a second MCPTT client 106 is an affiliated MCPTT group member of an MCPTT group that is a target of the remotely initiated MCPTT call.
b. an MCPTT private call, then the MCPTT user at the second MCPTT client 106 is permitted to initiate an MCPTT private call to the identified MCPTT user. The detailed steps are as follows:

At step 402, the MCPTT user at the first MCPTT client 102 initiates a remotely initiated MCPTT call request to the MCPTT user at the second MCPTT client 106.

At step 404, the first MCPTT client 102 sends a remotely initiated MCPTT call request towards an MCPTT server 104.

At step 406, the MCPTT server 104 checks whether the MCPTT user at the first MCPTT client 102 is authorized to initiate a remotely initiated MCPTT call request. If authorized, the MCPTT server 104 implicitly affiliates the MCPTT user at the second MCPTT client 106 to the MCPTT group if the MCPTT client at the second MCPTT client 106 is not already affiliated and notifies the MCPTT client at the second MCPTT client 106 of this affiliation change.

At step 408, If authorized, the MCPTT server 104 sends the corresponding remotely initiated MCPTT call request towards the MCPTT client at the second MCPTT client 106.

At step 410, based on the received information, the MCPTT client at the second MCPTT client 106 may notify the user of the remotely initiated MCPTT call request.

At step 412, optionally, the MCPTT client at the second MCPTT client 106 sends a remotely initiated MCPTT call response to the MCPTT server 104.

At step 414, after receiving the remotely initiated MCPTT call response from the MCPTT client at the second MCPTT client 106, the MCPTT server 104 informs the MCPTT client at the first MCPTT client 102 about successful remotely initiated MCPTT call request.

It will be noted that Steps 412 and 414 might not be sent, since it could be determined that the remotely initiated MCPTT call was successful by receiving the MCPTT call initiated by the MCPTT client at the second MCPTT client 106.

At step 416, based on the received information, the MCPTT client at the second MCPTT client 106 initiates an MCPTT call (either an MCPTT group call or an MCPTT private call) using normal MCPTT call establishment procedures (10.6.2.3.1.1.2 or 10.7.2.2) with implicit floor request. Herein, 10.6.2.3.1.1.2 or 10.7.2.2 may be 10.6.2.3.1.1.2 or 10.7.2.2 specified in 3GPP TS 23.379 V18.1.0. The MCPTT group call is a result of remotely initiated call request may be determined by the indication provided in the call initiation request and affiliation may be performed based on this indication.

It will be noted that steps 412 and 414 are received in this order. However, step 412 or step 414 or both might occur before or after step 416.

It will be noted that, on termination of an ongoing MCPTT group call, the MCPTT server 104 de-affiliates the MCPTT user at the second MCPTT client 106 from the MCPTT group if the second MCPTT client 106 is implicitly affiliated as defined in step 406 (at step 418).

The result of these procedures is an on-going MCPTT (group or private) call which includes the first MCPTT client 102.

In this method, existing information flows defined in 3GPP TS 23.379 are enhanced to include the affiliation to the target MCPTT group for the remote user will be performed by the MCPTT server on receiving of a remotely initiated MCPTT call request and the de-affiliation from the MCPTT group on termination of the on-going MCPTT group call.

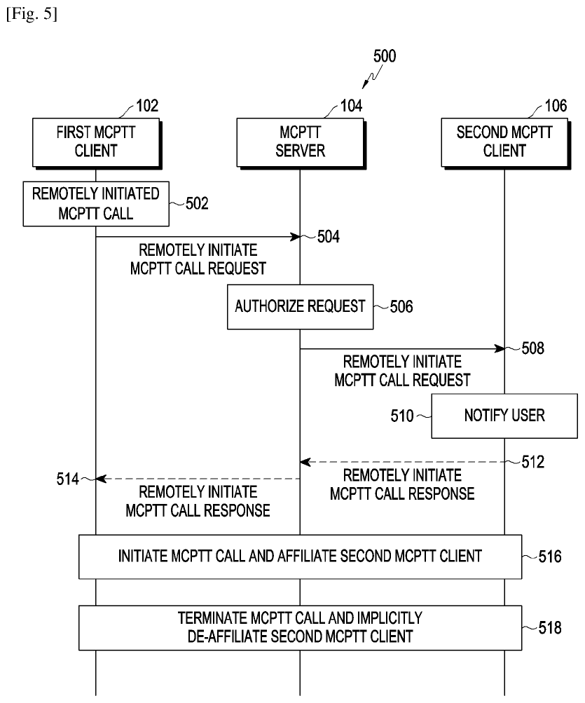

FIG. 5 depicts a flow diagram 500 for an affiliation and a de-affiliation of an MCPTT group by the MCPTT server on receiving of an MCPTT call setup request and on MCPTT call termination, according to embodiments as disclosed herein. At steps 502 and 504, the first MCPTT client 102 initiates the remotely initiated MCPTT call request to the MCPTT server 104. At step 506, the MCPTT server 104 authorizes the remotely initiated MCPTT call request. At step 508, the MCPTT server 104 sends the remotely initiated MCPTT call request to the second MCPTT client 106. At step 510, the remotely initiated MCPTT call request is notified to the second MCPTT client 106 user by the second MCPTT client 106. At step 512, the second MCPTT client 106 sends a remotely initiated MCPTT call request response to the MCPTT server 104. At step 514, the MCPTT server 104 sends the remotely initiated MCPTT call request response from the second MCPTT client 106 to the first MCPTT client 102. At step 516, the second MCPTT client 106 initiates the call establishment procedure with the first MCPTT client 102 by implicitly affiliating the second MCPTT client 106. At step 518, the MCPTT server 104 de-affiliates the second MCPTT client 106 once the on-going session has been terminated. Further, in some embodiments, some actions listed in FIG. 5 may be omitted

FIG. 5 will be described once again as follows. FIG. 5 illustrates a procedure for affiliating a remote user to a target MCPTT group is performed by an MCPTT server on reception of an MCPTT call setup request and de-affiliation from an MCPTT group on termination of on-going MCPTT group call.

In an embodiment, pre-conditions are as follows:

If an MCPTT user at a first MCPTT client 102 wants a resulting remotely initiated MCPTT call to be:
a. an MCPTT group call, then an MCPTT user at a second MCPTT client 106 is an affiliated MCPTT group member of an MCPTT group that is a target of a remotely initiated MCPTT call.
b. an MCPTT private call, then the MCPTT user at the second MCPTT client 106 is permitted to initiate an MCPTT private call to the identified MCPTT user. The detailed steps are as below:

At step 502, the MCPTT user at the first MCPTT client 102 initiates a remotely initiated MCPTT call request to the MCPTT user at the second MCPTT client 106.

At step 504, the MCPTT client 102 sends a remotely initiated MCPTT call request towards the MCPTT server 104.

At step 506, the MCPTT server 104 checks whether the MCPTT user at the first MCPTT client 102 is authorized to initiate a remotely initiated MCPTT call request.

At step 508, if authorized, the MCPTT server 104 sends the corresponding remotely initiated MCPTT call request towards the second MCPTT client 106.

At step 510, based on the received information, the second MCPTT client 106 may notify the user of the remotely initiated MCPTT call request.

At step 512, optionally, the second MCPTT client 106 sends a remotely initiated MCPTT call response to the MCPTT server 104.

At step 514, after receiving the remotely initiated MCPTT call response from the second MCPTT client, the MCPTT server 104 informs the first MCPTT client 102 about the successful remotely initiated MCPTT call request.

It will be noted that steps 512 and 514 might not be sent, since it could be determined that the remotely initiated MCPTT call was successful by receiving the MCPTT call initiated by the second MCPTT client 106.

At step 516, based on the received information, the second MCPTT client 106 initiates an MCPTT call (either an MCPTT group call or an MCPTT private call) using normal MCPTT call establishment procedures (10.6.2.3.1.1.2 or 10.7.2.2) with implicit floor request. Herein, 10.6.2.3.1.1.2 or 10.7.2.2 may be 10.6.2.3.1.1.2 or 10.7.2.2 specified in 3GPP TS 23.379 V18.1.0. If required, the MCPTT server 102 implicitly affiliates the MCPTT user at the second MCPTT client 106 to the MCPTT group, if the second MCPTT client 106 is not already affiliated and notifies the second MCPTT client 106 of this affiliation change. The MCPTT group call is a result of a remotely initiated call request may be determined by the indication provided in the call initiation request and affiliation may be performed based on this indication.

It will be noted that steps 512 and 514 are received in this order. However, steps 512 or 514 or both might occur before or after step 516.

It will be noted that, on termination of an ongoing MCPTT group call, the MCPTT server 104 de-affiliates the MCPTT user at the second MCPTT client 106 from the MCPTT group if the second MCPTT client 106 is implicitly affiliated as defined in step 506.

The result of these procedures is an on-going MCPTT (group or private) call which includes the first MCPTT client 102.

In this method, existing information flows defined in 3GPP TS 23.379 are enhanced to include the affiliation to the target MCPTT group for the remote user will be performed by the MCPTT server 104 on receiving of the call setup request which is a result of remotely initiated call request from an authorized user and the de-affiliation from the MCPTT group on termination of the on-going MCPTT group call.

In this method, existing information flows defined in 3GPP TS 23.379 are enhanced to include the affiliation to the target MCPTT group for the remote user will be requested by the MCPTT client while initiating the call and affiliation will be performed by the MCPTT server that is a result of remotely initiated call request from an authorized user. The de-affiliation from the MCPTT group will be performed by MCPTT server on termination of the on-going MCPTT group call.

Embodiments herein help in swiftly setting up of remotely initiated MCPTT group calls by allowing the receiving MCPTT client of the MCPTT user of the remotely initiated call request to auto affiliate to a target MCPTT group and de-affiliate from the target MCPTT group once the communication is successfully completed. With the proposed way of auto affiliation/de-affiliation can eliminate a need of explicit procedure to affiliate to an MCPTT group by the requesting client before sending of remotely initiated call request and de-affiliate from MCPTT group after successful completion of the MCPTT group communication.

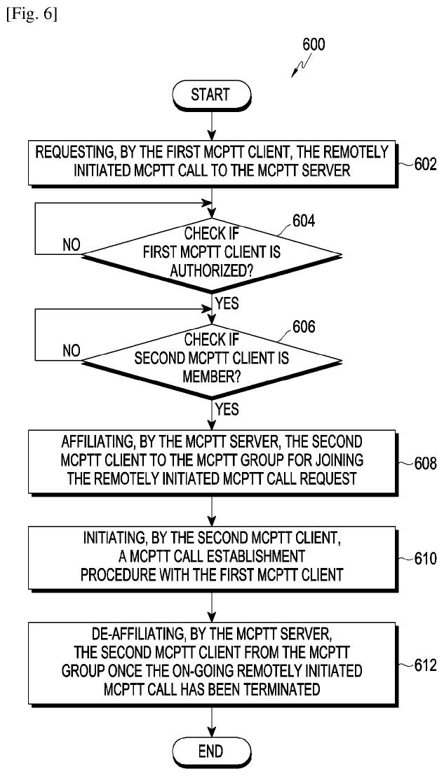

FIG. 6 depicts a method 600 managing remotely initiated MCPTT calls, according to embodiments as disclosed herein. At step 602, the method 600 includes requesting, by the first MCPTT client 102, the remotely initiated MCPTT call to the MCPTT server 104. At step 604, the method 600 includes checking, by an MCPTT server 104, whether a first MCPTT client 102 is authorized to initiate an MCPTT call request with a second MCPTT client 104, on receiving a remotely initiated MCPTT call request from the first MCPTT client 102. If the first MCPTT client 102 is authorized to remotely initiate the MCPTT call request with the second MCPTT client 106, at step 606, the method 600 includes checking, by the MCPTT server 104, if the second MCPTT client 106 is a member of the MCPTT group. At step 608, the method 600 includes affiliating, by the MCPTT server 104, the second MCPTT client 106 to the MCPTT group for joining the remotely initiated MCPTT call request if the second MCPTT client 106 is the member of the MCPTT group. At step 610, the method 600 includes initiating, by the second MCPTT client 106, an MCPTT call establishment procedure with the first MCPTT client 102. At step 612, the method 600 includes de-affiliating, by the MCPTT server 104, the second MCPTT client 106 from the MCPTT group once the on-going remotely initiated MCPTT call has been terminated. Further, in some embodiments, some actions listed in FIG. 6 may be omitted.

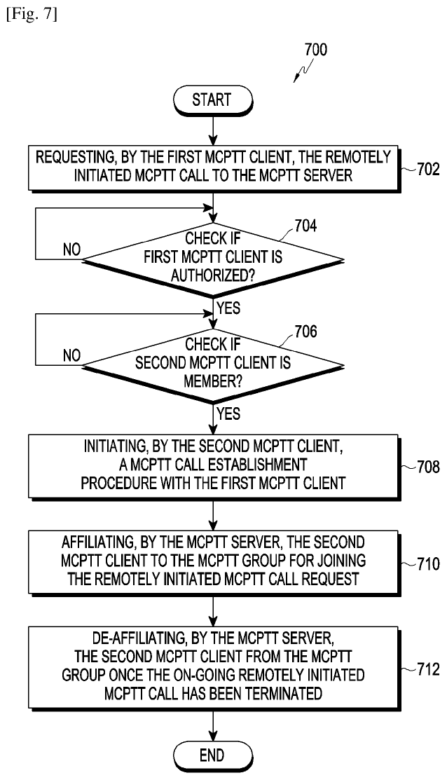

FIG. 7 depicts a method 700 of affiliating the second MCPTT user by the MCPTT server after initiating the MCPTT group call request, according to embodiments as disclosed herein. At step 702, the method 700 includes requesting, by the first MCPTT client 102, the remotely initiated MCPTT call to the MCPTT server 104. At step 704, the method 700 includes checking, by an MCPTT server 104, whether the first MCPTT client 102 is authorized to initiate the MCPTT call request with the second MCPTT client 104, on receiving a remotely initiated MCPTT call request from the first MCPTT client 102. If the first MCPTT client 102 is authorized to remotely initiate the MCPTT call request with the second MCPTT client 106, at step 706, the method 700 includes checking, by the MCPTT server 104, if the second MCPTT client 106 is a member of the MCPTT group. At step 708, the method 700 includes initiating, by the second MCPTT client 106, the MCPTT call establishment procedure with the first MCPTT client 102. At step 710, the method 700 includes affiliating, by the MCPTT server 104, the second MCPTT client 106 to the MCPTT group for joining the remotely initiated MCPTT call request if the second MCPTT client 106 is the member of the MCPTT group. At step 712, the method 700 includes de-affiliating, by the MCPTT server 104, the second MCPTT client 106 from the MCPTT group once the on-going remotely initiated MCPTT call has been terminated. Further, in some embodiments, some actions listed in FIG. 7 may be omitted.

Embodiments herein are related to mission critical services that are used by public safety communities (such as police, military, fire services, ambulance crews, and many more) in their operations that require high reliability, speed, quick accessibility and low latency operational support. Embodiments herein relates to one of the critical features used by the public safety communities, typically a dispatcher, instruct remotely to cause a remote Mission Critical Push to Talk (MCPTT) client at MCPTT UE (User Equipment) to initiate an MCPTT Private or MCPTT Group call by itself, without its MCPTT user explicitly initiating the call.

The affiliation to the target MCPTT group can be performed automatically at the MCPTT server on receiving the remotely initiated call request. This enables avoiding an additional step or procedure for affiliation and enhancing the feature with swift setup of the communication. To further reduce the communication setup, an alternate way of affiliation to a target MCPTT group can be performed automatically at the MCPTT server 104 on receiving of a target MCPTT group communication setup request which is the result of remotely initiated call request. As an another alternate, affiliation to the target MCPTT group for the remote user can be requested by the MCPTT client 102, 106 while initiating the call and affiliation can be performed by the MCPTT server 104. On successful completion of the communication on the target MCPTT group, the MCPTT server 104 can de-affiliate the remote user from the target MCPTT group if the affiliated implicitly as a result of remotely initiated call request.

Embodiments herein disclose systems and methods to automatically (de)-affiliate the remote user to/from a target MCPTT group for the remotely initiated MCPTT call. The receiving user of a remotely initiated call request can be implicitly affiliated by the server 104 on receiving the request to initiate the remotely initiated call from an authorized user. Embodiments herein disclose the server 104 implicitly affiliating a user of the call originator on receiving the call setup request which is a result of a remotely initiated call request from an authorized user. Embodiments herein disclose the server 104 can implicitly affiliate a user of the call originator on receiving the call setup request with an indication to perform affiliation. Embodiments herein disclose the server 104 implicitly de-affiliating a call originator while terminating the call which was established as a result of remotely initiated call request from an authorized user is received by the user of call originator.

Embodiments herein relate to one of the critical features used by the public safety communities, and typically a dispatcher, to cause an MCPTT client 102, and 106 to initiate an MCPTT Private or MCPTT Group call by itself, without its user explicitly initiating the call. Hence, it is essential for the MC services to provide a quick communication setup for this feature to be used by the public safety communities.

Embodiments herein are applicable for other services such as MCVideo and MCData. For the illustrative purposes, embodiments herein have been described considering the MCPTT service as an example of a MC service.

The MCPTT group can be performed automatically at the MCPTT server 104 on receiving the remotely initiated call request. This way an additional step or procedure for affiliation can be avoided and can enhance the feature with swift setup of the communication. To further reduce the communication setup, an alternate way of affiliation to a target MCPTT group can be performed automatically at the MCPTT server 104 on receiving a target MCPTT group communication setup request (which is the result of remotely initiated call request). As an another alternate, affiliation to the target MCPTT group for the remote user can be requested by the MCPTT client 102, 106 while initiating the call and affiliation will be performed by the MCPTT server 104. On successful completion of the communication on the target MCPTT group, the MCPTT server 104 can de-affiliate the remote user from the target MCPTT group if the affiliation is an implicit affiliation as a result of remotely initiated call request.

Embodiments herein disclose systems and methods to automatically (de)-affiliate remote user to/from a target MCPTT group for the remotely initiated MCPTT call. The receiving user of a remotely initiated call request can implicitly affiliate the server 104 on receiving the request to initiate a remotely initiated call from an authorized user. Embodiments herein disclose the server 104 implicitly affiliating a user of the call originator on receiving the call setup request which is a result of remotely initiated call request from an authorized user. Embodiments herein disclose affiliation of a user of the call originator by server on receiving the call setup request with indication to affiliate. Embodiments herein disclose the server 104 implicitly de-affiliating the call originator while terminating the call which was established as a result of remotely initiated call request from an authorized user received by the call originator.

Embodiments herein relate to one of the critical features used by the public safety communities, and typically a dispatcher, to cause a remote MCPTT client at MCPTT UE to initiate an MCPTT Private or MCPTT Group call by itself, without its user explicitly initiating the call. Hence, it is essential for the MC services to provide a quick communication setup for this feature to be used by the public safety communities.

Embodiments herein are applicable for other services such as Mission Critical video (MCVideo) and Mission Critical data (MCData). For the illustrative purpose, embodiments herein have been described considering the MCPTT service as an example MC service.

According to an embodiment, a method performed by a mission critical push to talk (MCPTT) server may include receiving a remotely initiated MCPTT call request from a first MCPTT client, checking whether an MCPTT user at the first MCPTT client is authorized to initiate a remotely initiated MCPTT call request, and in case that the first MCPTT client is authorized to remotely initiate the MCPTT call request, in case that a second MCPTT client is a member of an MCPTT group, and in case that the second MCPTT client is not affiliated to the MCPTT group, implicitly affiliating the second MCPTT client to the MCPTT group.

According to an embodiment, the method may further include initiating an MCPTT group call establishment procedure with the first MCPTT client.

According to an embodiment, the method may further include de-affiliating the second MCPTT client from the MCPTT group in case that the MCPTT call is terminated and in case that the second MCPTT client is implicitly affiliated.

According to an embodiment, the MCPTT call may be an MCPTT group call.

According to an embodiment, the MCPTT call may be an MCPTT private call.

According to an embodiment, the method may further include sending the remotely initiated MCPTT call request to the second MCPTT client, and receiving, from the second MCPTT client, a remotely initiated MCPTT call response to the remotely initiated MCPTT call request.

According to an embodiment, the method may further include, based on the remotely initiated MCPTT call response being received, informing the first MCPTT client about successful remotely initiated MCPTT call request.

According to an embodiment, a mission critical push to talk (MCPTT) server may include a communicator, and a processor connected to the communicator, and the processor may be configured to, receive, from a first MCPTT client via the communicator, a remotely initiated MCPTT call request, check whether an MCPTT user at the first MCPTT client is authorized to initiate a remotely initiated MCPTT call request, and in case that the first MCPTT client is authorized to remotely initiate the MCPTT call request, in case that a second MCPTT client is a member of an MCPTT group, and in case that the second MCPTT client is not affiliated to the MCPTT group, implicitly affiliate the second MCPTT client to the MCPTT group.

According to an embodiment, the processor may be further configured to initiate an MCPTT group call establishment procedure with the first MCPTT client.

According to an embodiment, the processor may be further configured to de-affiliate the second MCPTT client from the MCPTT group in case that the MCPTT call is terminated and in case that second MCPTT client is implicitly affiliated.

According to an embodiment, the MCPTT call may be an MCPTT group call.

According to an embodiment, the MCPTT call may be an MCPTT private call.

According to an embodiment, the processor may be further configured to, send, to the second MCPTT client via the communicator, the remotely initiated MCPTT call request, and receive, from the second MCPTT client via the communicator, a remotely initiated MCPTT call response to the remotely initiated MCPTT call request.

According to an embodiment, the processor may be further configured to, based on the remotely initiated MCPTT call response being received, inform the first MCPTT client about successful remotely initiated MCPTT call request.

According to an embodiment, a method for managing remotely initiated Mission Critical Push to Talk (MCPTT) calls may include receiving, by a MCPTT server (104), a remotely initiated MCPTT call request from a second MCPTT client (106); checking, by the MCPTT server (104), whether a MCPTT user at a first MCPTT client (102) is authorized to initiate a remotely initiated MCPTT call request for a MCPTT group; and determining by the MCPTT server (104) if the first MCPTT client (102) is authorized to remotely initiate the MCPTT call request with the second MCPTT client (106), and if the second MCPTT client (106) is a member of the MCPTT group and if the second MCPTT client (106) is not affiliated to the MCPTT group, then implicitly affiliating, by the MCPTT server (104), the second MCPTT client (106) to the MCPTT group to participate in the remotely initiated MCPTT call.

According to an embodiment, the method further comprises initiating, y the second MCPTT client (106), a MCPTT group call establishment procedure with the first MCPTT client (102).

According to an embodiment, the method further comprises de-affiliating, by the MCPTT server (104), the second MCPTT client (106) from the MCPTT group once the on-going MCPTT group call has been terminated and if the second MCPTT client (106) was implicitly affiliated by the MCPTT server (104).

According to an embodiment, the method further comprises requesting, by the first MCPTT client (102), the remotely initiated MCPTT call request to the MCPTT server (104).

According to an embodiment, the method further comprises: sending, by the MCPTT server (102), the remotely initiated MCPTT call request to the second MCPTT client (106); responding, by the second MCPTT client (106), to the remotely initiated MCPTT call request to the MCPTT server (104); and informing, by the MCPTT server (104), the response of the second MCPTT client (106) to the first MCPTT client (102).

According to an embodiment, the method further comprises notifying, by the MCPTT server (104), affiliation changes to the second MCPTT client (!06), if the second MCPTT client (106) is not a member of the MCPTT group.

According to an embodiment, the remotely initiated MCPTT call request is for a MCPTT group call.

According to an embodiment, the method further comprises implicitly affiliating, by the MCPTT server (104), the second MCPTT client while the second MCPTT client (106) initiates the MCPTT group call establishment procedure with the first MCPTT client (102) when the second MCPTT client (106) receives the remotely initiated MCPTT call request from the first MCPTT client (102).

According to an embodiment, a system (200) for managing remotely initiated Mission Critical Push to Talk (MCPTT) calls comprises: a first MCPTT client (102); a MCPTT server (104); and a second MCPTT client (106), and the system (200) is configured to: receive a remotely initiated MCPTT call request from a second MCPTT client (106); check whether a MCPTT user at a first MCPTT client (102) is authorized to initiate a remotely initiated MCPTT call request for a MCPTT group; determine if the first MCPTT client (102) is authorized to remotely initiate the MCPTT call request with the second MCPTT client (106), and if the second MCPTT client (106) is a member of the MCPTT group and if the second MCPTT client (106) is not affiliated to the MCPTT group, then implicitly affiliate the second MCPTT client (106) to the MCPTT group to participate in the remotely initiated MCPTT call; and initiate a MCPTT group call establishment procedure with the first MCPTT client (102).

According to an embodiment, the system (200) is further configured to de-affiliate the second MCPTT client (106) from the MCPTT group once the on-going MCPTT group call has been terminated and if the second MCPTT client (106) was implicitly affiliated by the MCPTT server (104).

According to an embodiment, the system (200) is further configured to request the remotely initiated MCPTT call request to the MCPTT server (104).

According to an embodiment, the system (200) is further configured to send the remotely initiated MCPTT call request to the second MCPTT client (106); respond to the remotely initiated MCPTT call request to the MCPTT server (104); and inform the response of the second MCPTT client (106) to the first MCPTT client (102).

According to an embodiment, the system (200) is further configured to notify affiliation changes to the second MCPTT client (106), if the second MCPTT client (106) is not a member of the MCPTT group.

According to an embodiment, the remotely initiated MCPTT call request is for a MCPTT group call.

According to an embodiment, the system (200) is further configured to implicitly affiliate the second MCPTT client (104) while the second MCPTT client (104) initiates the MCPTT group call establishment procedure with the first MCPTT client (102) when the second MCPTT client receives the remotely initiated MCPTT call request from the first MCPTT client (102).

According to an embodiment, a Mission Critical Push to Talk (MCPTT) server comprises a memory (330); at least one processor (340); a MCPTT group controller (310) connected to the memory (330) and the at least one processor (340) configured to: receive a remotely initiated MCPTT call request from a second MCPTT client (106); check whether a MCPTT user at a first MCPTT client (102) is authorized to initiate a remotely initiated MCPTT call request for a MCPTT group; determine if the first MCPTT client (102) is authorized to remotely initiate the MCPTT call request with the second MCPTT client (106), and if the second MCPTT client (106) is a member of the MCPTT group and if the second MCPTT client (106) is not affiliated to the MCPTT group, then implicitly affiliate the second MCPTT client (106) to the MCPTT group to participate in the remotely initiated MCPTT call.

According to an embodiment, the MCPTT group controller is further configured to de-affiliate the second MCPTT client (106) from the MCPTT group once the on-going remotely initiated MCPTT call has been terminated.

According to an embodiment, the remotely initiated MCPTT call request for a MCPTT group call.

The foregoing description of the specific embodiments will so fully reveal the general nature of the embodiments herein that others can, by applying current knowledge, readily modify and/or adapt for various applications such specific embodiments without departing from the generic concept, and, therefore, such adaptations and modifications should and are intended to be comprehended within the meaning and range of equivalents of the disclosed embodiments. It is to be understood that the phraseology or terminology employed herein is for the purpose of description and not of limitation. Therefore, while the embodiments herein have been described in terms of at least one embodiment, those skilled in the art will recognize that the embodiments herein can be practiced with modification within the spirit and scope of the embodiments as described herein.

1. A method performed by a mission critical push to talk (MCPTT) server, the method comprising:
receiving a remotely initiated MCPTT call request from a first MCPTT client;
checking whether an MCPTT user at the first MCPTT client is authorized to initiate a remotely initiated MCPTT call request; and
in case that the first MCPTT client is authorized to remotely initiate the MCPTT call request, in case that a second MCPTT client is a member of an MCPTT group, and in case that the second MCPTT client is not affiliated to the MCPTT group, implicitly affiliating the second MCPTT client to the MCPTT group.

2. The method of claim 1, further comprising:
initiating an MCPTT group call establishment procedure with the first MCPTT client.

3. The method of claim 1, further comprising:
de-affiliating the second MCPTT client from the MCPTT group in case that the MCPTT call is terminated and in case that the second MCPTT client is implicitly affiliated.

4. The method of claim 1, wherein the MCPTT call is an MCPTT group call.

5. The method of claim 1, wherein the MCPTT call is an MCPTT private call.

6. The method of claim 1, further comprising:
sending the remotely initiated MCPTT call request to the second MCPTT client; and
receiving, from the second MCPTT client, a remotely initiated MCPTT call response to the remotely initiated MCPTT call request.

7. The method of claim 6, further comprising:
based on the remotely initiated MCPTT call response being received, informing the first MCPTT client about successful remotely initiated MCPTT call request.

8. mission critical push to talk (MCPTT) server, comprising:
a communicator; and
a processor connected to the communicator and configured to:
receive, from a first MCPTT client via the communicator, a remotely initiated MCPTT call request,
check whether an MCPTT user at the first MCPTT client is authorized to initiate a remotely initiated MCPTT call request, and
in case that the first MCPTT client is authorized to remotely initiate the MCPTT call request, in case that a second MCPTT client is a member of an MCPTT group, and in case that the second MCPTT client is not affiliated to the MCPTT group, implicitly affiliate the second MCPTT client to the MCPTT group.

9. The MCPTT server of claim 8, wherein the processor is further configured to:
initiate an MCPTT group call establishment procedure with the first MCPTT client.

10. The MCPTT server of claim 8, wherein the processor is further configured to:
de-affiliate the second MCPTT client from the MCPTT group in case that the MCPTT call is terminated and in case that the second MCPTT client is implicitly affiliated.

11. The MCPTT server of claim 8, wherein the MCPTT call is an MCPTT group call.

12. The MCPTT server of claim 8, wherein the MCPTT call is an MCPTT private call.

13. The MCPTT server of claim 8, wherein the processor is further configured to:
send, to the second MCPTT client via the communicator, the remotely initiated MCPTT call request; and
receive, from the second MCPTT client via the communicator, a remotely initiated MCPTT call response to the remotely initiated MCPTT call request.

14. The MCPTT server of claim 8, wherein the processor is further configured to:
based on the remotely initiated MCPTT call response being received, inform the first MCPTT client about successful remotely initiated MCPTT call request.
